(19) United States
(12) Patent Application Publication
(10) Pub. No.: US 2016/0332264 A1
(43) Pub. Date: Nov. 17, 2016

(54) Accessory for a Cutting Device

(71) Applicant: Martin Albrecht, Lakewood, OH (US)

(72) Inventor: Martin Albrecht, Lakewood, OH (US)

(21) Appl. No.: 14/996,658

(22) Filed: Jan. 15, 2016

Related U.S. Application Data
(63) Continuation-in-part of application No. 14/867,058, filed on Sep. 28, 2015.
(60) Provisional application No. 62/179,614, filed on May 14, 2015.

(51) Int. Cl. B23K 37/02; B23K 9/28; B23K 7/10; B23K 10/00

(52) U.S. Cl. CPC B23K 37/0205; B23K 10/00; B23K 9/287; B23K 7/10

(57) ABSTRACT

A cutting device accessory that allows a user to easily maintain the proper distance or gap between the cutting device and the surface being cut, while the cutting device is being transported across said surface in any direction.

### CROSS-REFERENCE

This application is a continuation in part of patent application Ser. No. 14/867,058 filed on Sep. 28, 2015, which claims priority from Provisional Patent Application Ser. No. 62/179,614 filed on May 14, 2015.

### FIELD OF THE INVENTION

This invention relates to an accessory for use with a cutting device, such as a torch.

### BACKGROUND

Metal inert gas welding, or MIG welding, is well known in the art and is a welding process in which an electric arc forms between a consumable wire electrode and the work piece metal(s), which heats the work piece metal(s), causing them to melt, and join. Along with the wire electrode, a shielding gas feeds through the welding gun, which shields the process from contaminants in the air.

Heretofore, a welder performing a MIG welding operation had to maintain by hand the proper shield gas plume and electric arc gap while also attempting to move the welding device fluidly and continuously across a work piece to achieve a proper and acceptable welding bead, which could take years of experience to achieve on a consistent basis. Stated differently, heretofore, it has been difficult for novice and even semi-experienced welders to achieve an acceptable bead and weld on a consistent basis, which can be both frustrating and time consuming for a welder or welding technician attempting to learn the craft and lead to inconsistent results.

Oxy-fuel cutting is also a process that is well known in the art and involves using a torch, fuel gases and oxygen to cut metals. More specifically, in oxy-fuel cutting, a torch is used to heat metal to its kindling temperature. A stream of oxygen is then trained on the metal, burning it into a metal oxide that flows out of the kerf as slag. Similar to MIG welding, heretofore, it has been difficult for a novice welder or welding technician to make precision cuts using an oxy-fuel torch due to the need to continuously and fluidly move the cutting torch along the piece of metal being cut.

Similarly, plasma cutting is a process that cuts through electrically conductive materials by means of an accelerated jet of hot plasma. The basic plasma cutting process involves creating an electrical channel of ionized gas i.e. plasma from the plasma cutter itself, through the work piece to be cut, thus forming a completed electric circuit back to the plasma cutter via a grounding clamp. This is accomplished by a compressed gas (oxygen, air, inert and others depending on material being cut) which is blown through a focused nozzle at high speed toward the work piece. An electrical arc is then formed within the gas, between an electrode near or integrated into the gas nozzle and the work piece itself The electrical arc ionizes some of the gas, thereby creating an electrically conductive channel of plasma. As electricity from the cutter torch travels down this plasma it delivers sufficient heat to melt through the work piece. At the same time, much of the high velocity plasma and compressed gas blow the hot molten metal away, thereby separating i.e. cutting through the work piece. Plasma cutting is an effective means of cutting thin and thick materials alike. Hand-held torches can usually cut up to 38 mm thick steel plate, and stronger computer-controlled torches can cut steel up to 150 mm thick. Since plasma cutters produce a very hot and very localized “cone” to cut with, they are extremely useful for cutting sheet metal in curved or angled shapes. Similar to oxy-fuel cutting, heretofore, it has been difficult for a novice welder or welding technician to make precision cuts using a plasma cutter due to the need to continuously and fluidly move the cutter along the surface being cut.

Consequently, there is a long felt need in the art for a welding or cutting device accessory that allows the user to easily maintain the proper electrical arc gap between the torch/cutting device and the surface being cut, and that improves consistency of the shield gas plume by reducing the variation of gap between the shield gas nozzle and the metal surface while in motion. There is also a long felt need in the art for a cutting device accessory that provides the user with a means for more concisely and fluidly moving the cutting device along a desired path. Finally, there is a long felt need in the art for a cutting device accessory that accomplishes all of the forgoing objectives in a cutting operation, and that is relatively inexpensive to manufacture and safe and easy to use.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed herein, in one aspect thereof, is an accessory for a cutting device that: (i) enables a user to easily maintain the proper electrical arc gap between the cutting device and a work surface while the cutting device is in motion; and (ii) provides the user with a means for more concisely and fluidly moving the cutting device along a desired cutting path.

In a preferred embodiment of the present invention, the cutting device accessory comprises a body portion, an arm having a first end and a second end, and a rotatable ball positioned at the second end of said arm, as described more fully below. The cutting device accessory of the present invention accomplish all of the forgoing objectives, as well as others, in a MIG welding or oxy-fuel or plasma cutting operation, and is relatively inexpensive to manufacture and safe and easy to use.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 is a perspective view of one embodiment of the accessory device of the present invention securely attached to an end of a cutting device.

FIG. 2 is a perspective view of the accessory device of FIG. 1.

FIG. 3 is an exploded view of the accessory device of FIG. 1.

FIG. 4 is a perspective view of an alternative embodiment of the accessory device of the present invention securely attached to an end of a cutting device.

FIG. 5 is a perspective view of the accessory device of FIG. 4.

FIG. 6 is an exploded view of the accessory device of FIG. 4.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details.

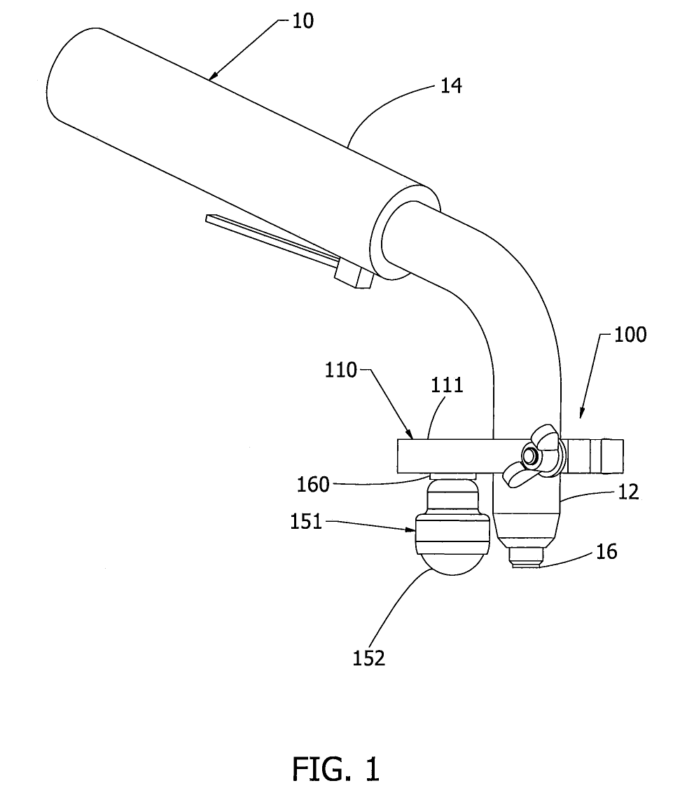

Referring initially to the drawings, FIG. 1 is a perspective view of one embodiment of the cutting accessory device 100 of the present invention securely attached to cutting device 10. More specifically, cutting device 10 is comprised of a head portion 12, a handle portion 14, and a tip 16 located at the end of head portion 12 opposite handle portion 14. When device 10 is in use, a flame or torch (not shown) extends from said tip 16 of device 10 and can be applied to a work piece.

Device 100 is removably and repositionably attached to head portion 12, and is preferably comprised of a body portion 110, a fastener 120, and a rotatable ball assembly 150. Unless otherwise stated herein, device 100 is preferably comprised of durable materials, such as steel, aluminum, heat resistant plastic or other material capable of being exposed to elevated temperatures due to the proximity of device 100 to cutting device 10.

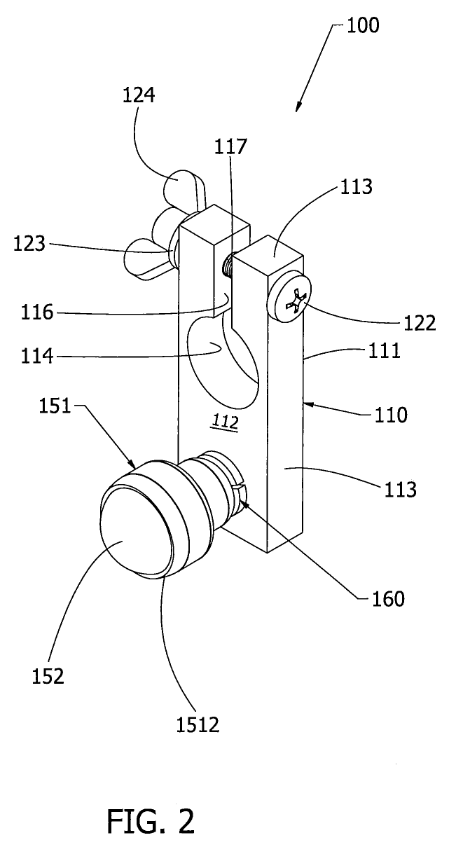

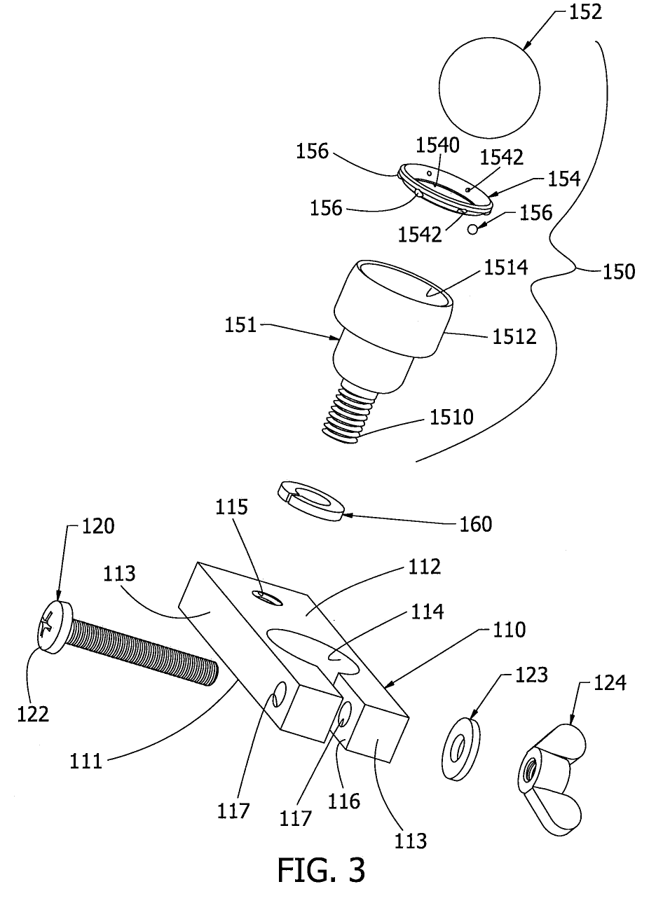

As best shown in FIGS. 2 and 3, body portion 110 is preferably comprised of an inboard surface 111, an outboard surface 112, a plurality of sides 113, a first continuous opening 114, a second opening 115 in outboard surface 112, a slot 116, and a fastener opening 117. Inboard surface 111 refers to the surface of body portion 110 facing towards the handle portion 14 of cutting device 10 when device 100 is properly installed on head portion 12, as shown in FIG. 1. Outboard surface 112 refers to the surface of body portion 110 opposite of inboard surface 111 and facing in the opposite direction of handle portion 14 of cutting device 10 when device 100 is properly installed on head portion 12, as shown in FIG. 1.

First continuous opening 114 extends between inboard surface 111 and outboard surface 112 and is shaped and sized accordingly to receive head portion 12 of cutting device 10. Similarly, second opening 115 may also extend between inboard surface 111 and outboard surface 112, or may extend only a portion of the way from outboard surface 112 in the direction of inboard surface 111. Second opening 115 is shaped and sized accordingly to receive a portion of rotatable ball assembly 150, as described more fully below, and is preferably threaded. As referenced above, body portion 110 is also preferably comprised of slot 116 that extends between said inboard surface 111 and said outboard surface 112, as well as between first continuous opening 114 and one of said plurality of sides 113, as best shown in FIGS. 2 and 3. As more fully explained below, the width of slot 116 is adjustable by tightening/loosening fastener 120, and slot 116 is useful for installing/removing device 100 from head portion 12 of cutting device 10.

As best illustrated in FIG. 2, fastener opening 117 preferably extends through body portion 110 from one side 113, across slot 116, to a second opposing side 113 and is sized and shaped accordingly to receive fastener 120, as more fully explained below. In a preferred embodiment of the present invention, fastener opening 117 is not threaded, though it is contemplated that fastener opening 117 could also be threaded without affecting the overall scope of the present invention.

Fastener 120 may be any fastener commonly known in the art and is preferably comprised of a threaded screw 122, a washer 123 and a nut 124, such as a wing nut for easy handling. Notwithstanding, as mentioned above, if fastener opening 117 is threaded, washer 123 and nut 124 may be eliminated and fastener 120 may simply be screwed into fastener opening 117. As explained more fully below, fastener 120 is useful for slightly increasing or decreasing the size of first continuous opening 114 and slot 116 to install/remove device 100 from head portion 12 of cutting or welding device 10, and for removably securing device 100 to head portion 12.

Rotatable ball assembly 150 may be any type of rotatable ball assembly known in the art, wherein a ball is retained in an opening in a device and permitted to rotate therein with a portion of the ball extending beyond the device and capable of contacting a work surface or work piece. As best shown in the embodiment depicted FIGS. 1 through 3, rotatable ball assembly 150 is preferably comprised of an arm portion 151, a ball 152, a retainer ring 154 and a plurality of ball bearings 156. More specifically, arm portion 151 is an elongated member comprised of a first end 1510, an opposing second end 1512 and an opening 1514 in said second end 1512 for receipt of a portion of ball 152, as explained more fully below. The diameter of opening 1514 is slightly smaller than the diameter of ball 152, which enables ball 152 to be rotatably retained by arm portion 151, but still extend beyond arm portion 151 for contacting a work surface or work piece.

In a preferred embodiment, at least a portion of first end 1510 of arm portion 151 is threaded to correspond to the threads in second opening 115 in body portion 110. In this manner, rotatable ball assembly 150 may be removably attached to body portion 110. As shown in FIG. 3, a lock washer 160 may also be used to better secure rotatable ball assembly 150 to body portion 110.

As best shown in FIG. 3, retainer ring 154 is a generally saucer-shaped ring comprised of a continuous opening 1540 therein for partial receipt of ball 152, and a plurality of smaller ball bearing openings 1542 positioned in spaced apart fashion along the circumference of retainer ring 154 for partial receipt of ball bearings 156. More specifically, retainer ring 154 is positioned within opening 1514 in arm portion 151, wherein each of ball bearings 156 is positioned between a lip (not shown) in the interior of arm portion 151 and retainer ring 154 wherein a portion of each of said ball bearings 156 extends through a corresponding ball bearing opening 1542 for contact with ball 152. When properly assembled, as shown in FIG. 2, ball 152 freely rotates on the second end 1512 of arm portion 151.

As an important feature of the present invention, it is preferred that ball 152 extend (in the outboard direction) between ⅛ and ½ of an inch beyond tip 16 of cutting device 10. In a most preferred embodiment of the present invention, ball 152 will extend ¼ of an inch beyond tip 16 of cutting device 10, thereby maintaining a consistent and desirable gap between tip 16 and the work piece being cut (not shown) while cutting tool 10 is being rolled (via said rotatable ball assembly 150) along said work piece. A user of device 100 will appreciate that he/she can control the size of the gap (i.e., between tip 16 of cutting device 10 and a work piece) by properly positioning device 100 along head portion 12 so that the farthest portion of ball 152 extends the desired distance (i.e., ¼ of an inch) beyond tip 16 in the direction of the work surface or work piece.

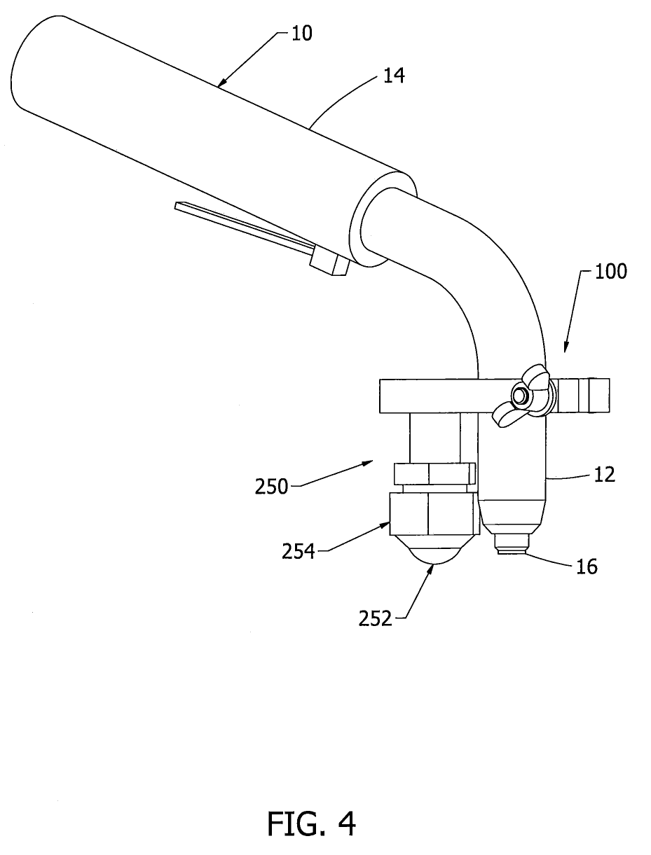

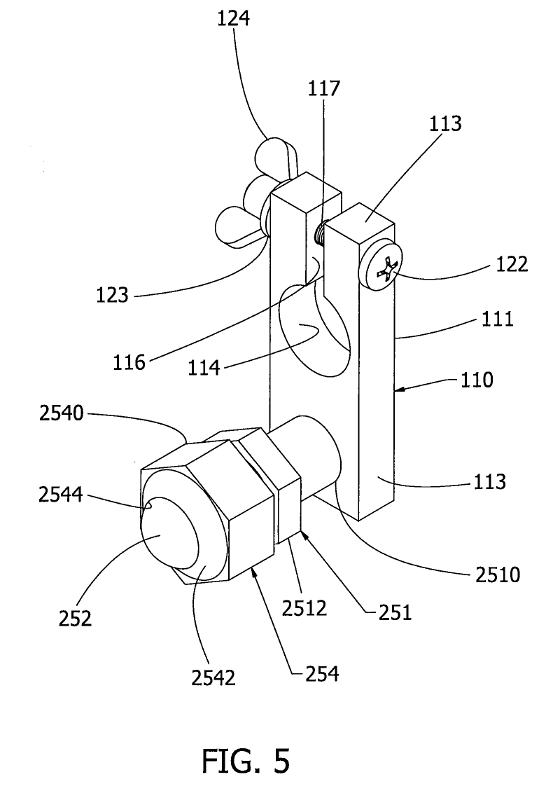

As previously stated, rotatable ball assembly 150 may take many different forms, provided that it includes a rotatable ball at the end of an arm portion and permits a user (not shown) to guide cutting device 10 along a work surface/piece in any direction while maintaining a consistent and desirable gap between tip 16 and said work surface/piece. FIGS. 4-6 depict an alternative embodiment of a rotatable ball assembly 250 comprised of an arm portion 251, a ball 252, and a cap 254.

More specifically, arm portion 251 is an elongated member comprised of a first end 2510, an opposing second end 2512 and an opening 2514 in said second end 2512 for receipt of a portion of ball 252, as explained more fully below. The diameter of opening 2514 is slightly smaller than the diameter of ball 252, which enables ball 252 to be rotatably retained by arm portion 251 and cap 254, but still extend beyond cap 254 (in an outboard direction) for contacting a work surface (not shown), as described more fully below. In a preferred embodiment, at least a portion of the exterior surface of first end 2510 of arm portion 251 is threaded to correspond to the threads in second opening 115 in body portion 110. In this manner, rotatable ball assembly 250 may be removably attached to body portion 110. Likewise, at least a portion of the exterior surface of said second end 2512 is also threaded to correspond to the threads in cap 254, as explained more fully below.

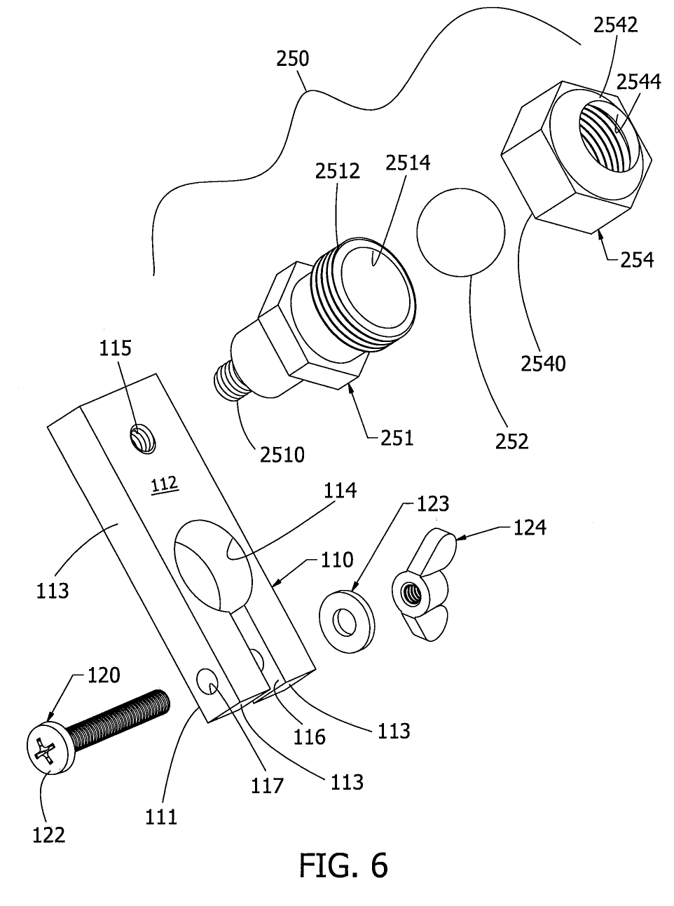

Similar to ball 152, ball 252 can also be any spherical ball known in the art with a relatively smooth surface. As best shown in FIG. 6, cap 254 is similar in appearance to an interior threaded nut, and is comprised of an inboard end 2540, and outboard end 2542 and an opening 2544 extending between said inboard end 2540 and said outboard end 2542. More specifically, at least a portion of the interior surface of cap 254 on inboard end 2540 is threaded to correspond with the threads on the exterior surface of said second end 2512 of arm portion 251. Additionally, the diameter of opening 2544 on the outboard end 2542 is smaller than both the diameter of opening 2544 on the inboard end 2540 of cap 254 and the diameter of ball 252, whereas the diameter of opening 2544 on the inboard end 2540 of cap 254 is larger than the diameter of ball 252. The diameter of opening 2514 on arm portion 251 is also smaller than the diameter of ball 252. In this manner, ball 252 can be placed within opening 2544 before cap 254 is removably attached to second end 2512 of arm portion 251. Once cap 254 is attached to arm portion 251, ball 252 is rotatably positioned between arm portion 251 and cap 254 with at least a portion of ball 252 extending beyond the outboard end 2542 of cap 254 for contacting a work surface or work piece.

Similar to rotatable ball assembly 150, it is also preferred that ball 252 extend (in the outboard direction) between ⅛ and ¼ of an inch beyond tip 16 of cutting device 10 when accessory device 100 is properly installed on cutting device 10. In a most preferred embodiment of the present invention, ball 252 will extend ¼ of an inch beyond tip 16 of cutting device 10, thereby maintaining a consistent and desirable gap between tip 16 and the work surface being cut (not shown) while cutting tool 10 is being rolled (via said rotatable ball assembly 250) along said work surface. A user of device 100 will appreciate that he/she can control the size of the gap (i.e., between tip 16 of cutting device 10 and a work surface/piece) by properly positioning device 100 along head portion 12 so that the farthest portion of ball 252 extends the desired distance (i.e., approximately a ¼ of an inch) beyond tip 16 in an outboard direction.

Having now described the general structure of a preferred embodiment of accessory device 100, its function will now be described in general terms. A welder or technician (not shown) desiring to improve the consistency of a weld or make a precise cut in a work piece (not shown) may attach device 100 to a welding or cutting device, such as device 10, by placing the head portion 12 into opening 114, rotating said device 100 about said head portion 12 into a desired position, and tightening fastener 120 to secure device 100 to device 10. As discussed above, a desired position of device 100 about said head portion 12 is such that the size of the gap or distance between tip 16 of cutting device 10 and a work piece when ball 152, 252 is in contact with said work piece is approximately ¼ of an inch. The technician may then guide the cutting device along the work piece via ball 152 or 252 in virtually any direction he/she desires, while maintaining a relatively constant distance between device 10 and said work piece.

Other variations are also within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An accessory device comprising:
a body portion; and
a rotatable ball assembly.

2. The accessory device of claim 1 wherein said body portion is comprised of an inboard surface, an outboard surface and a continuous opening extending between said inboard surface and said outboard surface.

3. The accessory device of claim 2 wherein said body portion is further comprised of at least one side, a second continuous opening extending between said inboard surface and said outboard surface, and a slot extending between said continuous opening and said at least one side.

4. The accessory device of claim 3 wherein said slot also extends between said inboard surface and said outboard surface.

5. The accessory device of claim 1 wherein said rotatable ball assembly is comprised of an arm portion, a retainer ring and a ball.

6. The accessory device of claim 2 further comprising a screw, wherein said continuous opening is adjustable in size by turning said screw.

7. The accessory device of claim 5 further comprising a plurality of ball bearings.

8. The accessory device of claim 7, wherein said retainer ring further comprises a plurality of spaced apart ball bearing openings.

9. The accessory device of claim 1 wherein said rotatable ball assembly is comprised of an arm portion and a ball, wherein said arm portion is further comprised of a first end attached to said body portion and a second end, and further wherein said ball is rotatably attached to said second end.

10. An accessory device for attachment to a cutting device comprised of a handle portion, a head portion and a tip that is positioned a desirable distance away from a work piece comprising:
a body portion; and
a rotatable ball assembly comprised of an arm portion and a ball.

11. The accessory device of claim 10 wherein said arm portion is further comprised of a first end attached to said body portion and a second end, and further wherein said ball is rotatably attached to said second end.

12. The accessory device of claim 11 wherein said accessory device is positioned along said cutting device in such a manner that when the ball is in contact with said work piece, the tip is positioned a desirable distance away from said work piece.

13. The accessory device of claim 12 wherein said desirable distance is between ⅛ and ½ of an inch.

14. The accessory device of claim 12 wherein said desirable distance is approximately ¼ of an inch.

15. An accessory device comprising:
a body portion with an adjustable opening therein; and
a rotatable ball assembly comprised of an arm portion and a ball.

16. The accessory device of claim 15 wherein said arm portion is comprised of a first end and a second end, wherein said first end is removably attached to said body portion and said ball is rotatably attached to said second end.

17. The accessory device of claim 15 wherein said rotatable ball assembly further comprises a plurality of ball bearings.

18. The accessory device of claim 17 wherein said ball is positioned adjacent to one or more of said plurality of ball bearings.

19. The accessory device of claim 15 wherein said arm portion further comprises an opening therein, and further wherein a retainer ring in positioned within said opening in said arm portion.

20. The accessory device of claim 15 attached to a cutting device comprised of a handle portion, a head portion and a tip, wherein said ball extends beyond the tip a distance of between ⅛ and ½ of an inch in the direction of a work piece.
